(19) United States
(12) Patent Application Publication
(10) Pub. No.: US 2013/0054236 A1
(43) Pub. Date: Feb. 28, 2013

(54) METHOD FOR THE DETECTION OF SPEECH SEGMENTS

(71) Applicants: Carlos Garcia Martinez, Madrid (ES); Helenca Duxans Barrobés, Madrid (ES); Mauricio Sendra Vicens, Madrid (ES); David Cadenas Sanchez, Madrid (ES)

(72) Inventors: Carlos Garcia Martinez, Madrid (ES); Helenca Duxans Barrobés, Madrid (ES); Mauricio Sendra Vicens, Madrid (ES); David Cadenas Sanchez, Madrid (ES)

(73) Assignee: TELEFONICA, S.A., Madrid (ES)

(21) Appl. No.: 13/500,196

(22) PCT Filed: Oct. 7, 2010
(86) PCT No.: PCT/EP10/65022

§ 371 Date: Nov. 12, 2012

(30) Foreign Application Priority Data
Oct. 8, 2009 (ES) P200930819

(51) Int. Cl. G10L 15/20

(52) U.S. Cl. 704/233; 704/E15.039

(57) ABSTRACT

A method for the detection of noise and speech segments in a digital audio input signal, the input signal being divided into a plurality of frames including a first stage in which a first classification of a frame as noise is performed if the mean energy value for this frame and the previous N frames is not greater than a first energy threshold, N>1, a second stage in which for each frame that has not been classified as noise in the first stage it is decided if the frame is classified as noise or as speech based on combining at least a first criterion of spectral similarity of the frame with acoustic noise and speech models, a second criterion of analysis of the energy of the frame and a third criterion of duration, and of using a state machine for detecting the beginning of a segment as an accumulation of a determined number of consecutive frames with acoustic similarity greater than a first threshold and for detecting the end of the segment; a third stage in which the classification as speech or as noise of the signal frames carried out in the second stage is reviewed using criteria of duration.

### TECHNICAL FIELD

The present invention belongs to the area of speech technology, particularly speech recognition and speaker verification, specifically to the detection of speech and noise.

### BRIEF DISCUSSION OF RELATED ART

Automatic speech recognition is a particularly complicated task. One of the reasons is the difficulty of detecting the beginnings and ends of the speech segments pronounced by the user, suitably discriminating them from the periods of silence occurring before beginning to speak, after finishing, and those periods resulting from the pauses made by said user to breathe while speaking.

The detection and delimitation of pronounced speech segments is fundamental for two reasons. Firstly, for computational efficiency reasons: the algorithms used in speech recognition are fairly demanding in terms of computational load, so applying them to the entire acoustic signal, without eliminating the periods in which the voice of the user is not present, would involve triggering the processing load and, accordingly, would cause considerable delays in the response of recognition systems. Secondly, and not less importantly, for efficacy reasons: the elimination of signal segments which do not contain the voice of the user considerably limits the search space of the recognition system, substantially reducing its error rate. For these reasons, the commercial automatic speech recognition systems include a module for the detection of noise and speech segments.

As a consequence of the importance of the speech segment detection, a number of efforts have been made to suitably perform this task.

For example, Japanese patent application JP-A-9050288 discloses a method for the detection of speech segments. Specifically, the beginning and end points of the speech segment are determined by means of comparing the amplitude of the input signal with a threshold. This method has the drawback that the operation depends on the level of the noise signal, so its results are not suitable in the presence of noises with a large amplitude.

In turn, Japanese patent application JP-A-1244497 discloses a method for the detection of speech segments based on calculating the energy of the signal. Specifically, the mean energy of the first speech frames is calculated and the value obtained is used as an estimation of the energy of the noise signal overlapping the voice. Then the voice pulses are detected by means of comparing the energy of each signal frame with a threshold dependent on the estimated energy of the noise signal. The possible variability of energy values of the noise signal is thus compensated. However, the method does not work correctly when there are noise segments with a large amplitude and short duration.

U.S. Pat. No. 6,317,711 also discloses a method for the detection of speech segments. In this case, a feature vector is obtained for each signal frame by means of LPC cepstral and MEL cepstral parameterization. Then the minimum value of said vector is sought and all the elements of said vector are normalized by dividing their value by this minimum value. Finally, the value of the normalized energy is compared with a set of predetermined thresholds to detect the speech segments. This method offers better results than the previous one does, although it still has difficulties to detect speech segments in unfavorable noise conditions.

U.S. Pat. No. 6,615,170 discloses an alternative method for the detection of speech segments which, rather than being based on the comparison of a parameter or a parameter vector with a threshold or set of thresholds, is based on training acoustic noise and speech models and on comparing the input signal with said models, determining if a determined frame is speech or noise by means of maximization of the maximum verisimilitude.

Besides these patents and other similar ones, the treatment of the task of the detection of noise and speech segments in the scientific literature is quite extensive, there being a number of articles and lectures presenting different methods of carrying out said detection. Thus, for example, “Voice Activity Detection Based on Conditional MAP Criterion” (Jong Won Shin, Hyuk Jin Kwon, Suk Ho Jin, Nam Soo Kim; in IEEE Signal Processing Letters, ISSN: 1070-9908, Vo. 15, February 2008) describes a method for the detection of speech based on a variant of the MAP (maximum a posteriori) criterion which classifies signal frames into speech or noise based on spectral parameters and using different thresholds depending on the immediately prior classification results.

With respect to the normalization, the recommendation of a method for the detection of speech included in the ETSI distributed speech recognition standard (ETSI ES 202 050 v1.1.3. Distributed Speech Recognition; Advanced Front-end Feature Extraction Algorithm; Compression Algorithms. Technical Report ETSI ES 202 050, ETSI) should be pointed out. The method recommended in the standard is based on calculating three parameters of the signal for each frame thereof and comparing them with three corresponding thresholds, using a set of several consecutive frames to make the end speech/noise decision.

However, despite the large number of proposed methods, the task of speech segment detection today continues to present considerable difficulties. The methods proposed until now, i.e., those which are based on comparing parameters with thresholds and those which are based on statistical classification, are insufficiently robust in unfavorable noise conditions, especially in the presence of non-stationary noise, which causes an increase of speech segment detection errors in such conditions. For this reason, the use of these methods in particularly noisy environments, such as the interior of automobiles, presents significant problems.

In other words, the method for the detection of speech segments proposed until now, i.e., those based on comparing parameters of the signal with thresholds and those based on statistical comparison, present significant problems of robustness in unfavorable noise environments. Their operation is particularly degraded in the presence of non-stationary noises.

As a consequence of the lack of robustness in determined conditions, it is unfeasible or particularly difficult to use automatic speech recognition systems in determined environments (such as the interior of automobiles for example). In these cases, the use of methods for the detection of speech segments based on comparing parameters of the signal with thresholds, or based on statistical comparisons, do not provide suitable results. Accordingly, automatic speech recognizers obtain a number of erroneous results and frequent rejections of user pronunciations, which makes it extremely difficult to use systems of this type.

### BRIEF SUMMARY

The invention relates to a method for the detection of speech segments

The present proposal attempts to solve such limitations by offering a method for the detection of speech segments that is robust in noisy environments, even in the presence of non-stationary noises. To that end, the proposed method is based on combining three criteria for making the decision of classifying the segments of the input signal as speech or as noise. Specifically, a first criterion relating to the energy of the signal based on the comparison with a threshold is used. A statistical comparison of a series of spectral parameters of the signal with speech and noise models is used as a second criterion. And a third criterion based on the duration of the different voice and noise pulses based on the comparison with a set of thresholds is used.

The proposed method for the detection of speech segments is performed in three stages. In the first stage the signal frames the energy of which does not exceed a certain energy threshold, the value of which is automatically updated in real time depending on the existing noise level, are discarded. In the second stage, the speech frames that are not discarded are subjected to a decision-making method combining the three criteria set forth in order to classify said frames as speech or noise. Finally, in the third stage the noise and speech segments obtained are validated according to a criterion of duration, the segments the duration of which does not exceed a certain threshold being eliminated.

Combining the three criteria and performing the method in the three proposed stages allows obtaining the noise and speech segments with a greater precision that those that are obtained with other methods, especially in unfavorable noise conditions. This segment detection is carried out in real time and can therefore be applied in automatic interactive speech recognition systems.

The invention provides a method for the detection of noise and speech segments in a digital audio input signal, said input signal being divided into a plurality of frames comprising:
a first stage in which a first classification of a frame as noise is performed if the mean energy value for this frame and the previous N frames is not greater than a first energy threshold, N being an integer greater than 1;
a second stage in which for each frame that has not been classified as noise in the first stage it is decided if said frame is classified as noise or as speech based on combining at least a first criterion of spectral similarity of the frame with acoustic noise and speech models, a second criterion of analysis of the energy of the frame with respect to a second energy threshold, and a third criterion of duration comprising using a state machine for detecting the beginning of a segment as an accumulation of a determined number of consecutive frames with acoustic similarity greater than a first acoustic threshold and another determined number of consecutive frames with acoustic similarity less than said first acoustic threshold for detecting the end of said segment;
a third stage in which the classification of the signal frames as speech or as noise carried out in the second stage is reviewed using criteria of duration, classifying the speech segments having a duration of less than a first minimum segment duration threshold, as well as those which do not contain a determined number of consecutive frames simultaneously exceeding said acoustic threshold and said second energy threshold as noise.

In other words, the method of the invention is performed in three stages: a first stage based on energy threshold, a second stage of multi- criterion decision-making and a third stage of duration check.

The decision-making of the second stage is based on:
On one hand, the simultaneous use of three criteria: spectral similarity, energy value and duration (a minimum number of consecutive frames that are spectrally similar to the noise model at the end of the segment is necessary for considering the latter to be finished).
On the other hand, the use of different states, which introduces a certain hysteresis both for detecting the beginning of the segment (it is necessary to accumulate several frames with acoustic similarity greater than the threshold) and for the end thereof (hysteresis).

This makes the operation better by eliminating false segment beginnings and ends.

Two duration thresholds are preferably used in the third stage:
A first minimum segment duration threshold.
A second duration threshold of consecutive frames which meet both the criterion of acoustic similarity and that of minimum energy.

The use of this double threshold improves in cases of impulsive noises and mumbling of the user.

The invention can be used as part of a speech recognition system. It can also be used as part of a speaker identification or verification system, or as part of an acoustic language detection system or of a multimedia content acoustic indexing system.

The use of the criteria of duration, both in the second and in the third stage, means that the method will correctly classify non-stationary noises and mumbling of the user, something which the methods known up until now did not do: the criteria based on energy thresholds are not capable of discriminating non-stationary noises with high energy values, whereas the criteria based on comparing acoustic characteristics (whether they are in the time domain or in the spectral domain) are not capable of discriminating guttural sounds and mumbling of the user given their acoustic similarity with speech segments. However, combining spectral similarity and energy allows discriminating a larger number of noises of this type from speech segments. And the use of criteria of duration allows preventing signal segments with noises of this type from being erroneously classified as speech segments.

On the other hand, the manner in which the three criteria are combined in the described stages of the method optimizes the capacity of correctly classifying noise and speech segments. Specifically, the application of a first energy threshold prevents segments with a low energy content from being taken into account in the acoustic comparison. Unpredictable results, which are typical in methods of detection based on acoustic comparison which do not filter out segments of this type and those which compare a mixed feature vector with spectral and energy characteristics, are thus prevented. The use of a second energy threshold prevents eliminating speech segments with low energy levels in the first stage, since it allows using a first rather unrestrictive energy threshold which eliminates only those noise segments with a very low energy level, leaving the elimination of noise segments of a higher power for the second stage, in which the more restrictive second energy threshold intervenes. The combined use of acoustic and energy thresholds in the second stage allows discriminating noise segments from speech segments: on one hand, the demand to exceed both thresholds prevents classifying the high energy noise segments but with spectral characteristics that are different from speech (non-stationary noises, such as blows or cracking) and the noise segments that are acoustically similar to speech but with low energy (mumbling and guttural sounds) as speech; on the other hand, the use of two independent comparisons instead of a mixed feature (acoustic and energy) vector allows adjusting the method of detection. The use of criteria of duration in this second stage (need to exceed an accumulated acoustic score threshold at the beginning of the speech segment and to link a minimum number of noise signal frames at the end of said segment together) allows detecting as noise the signal segments with non-stationary noises of a short duration, as well as classifying segments corresponding to sounds which, though they are speech, have a lower tone, as is the case of phonemes corresponding to occlusive and fricative consonants (k, t, s, . . . ), as speech. Finally, the use of the third stage allows performing a final filtering, eliminating the noise segments which have been classified as speech but do not reach the minimum duration, correcting the errors of the first two stages of the method with a different procedure with respect to all those used in other methods.

The correct classification of signal frames with high energy noises and with mumbling makes it possible to use the method in recognition systems in different environments: at the office, in the home, automobile interiors, etc., and with different use channels (microphone or telephone). It is also applicable in different types of vocal applications: vocal information services, vocal equipment control, etc.

### BRIEF DESCRIPTION OF THE DRAWINGS

To complement the description that is being made and for the purpose of aiding to better understand the features of the invention, an embodiment of the invention is briefly described below as an illustrative and non-limiting example thereof.

FIG. 1 depicts a block diagram of the method for the detection of speech segments.

FIG. 2 shows a state diagram of the noise and speech frame classification process.

FIG. 3 shows the method for checking frames which simultaneously comply with acoustic and energy thresholds.

FIG. 4 depicts the flowchart of the validation of duration thresholds.

### DETAILED DESCRIPTION

According to the preferred embodiment of the invention, the method for the detection of noise and speech segments is carried out in three stages.

As a step prior to the method, the input signal is divided into frames of a very short duration (between 5 and 50 milliseconds), which are processed one after the other.

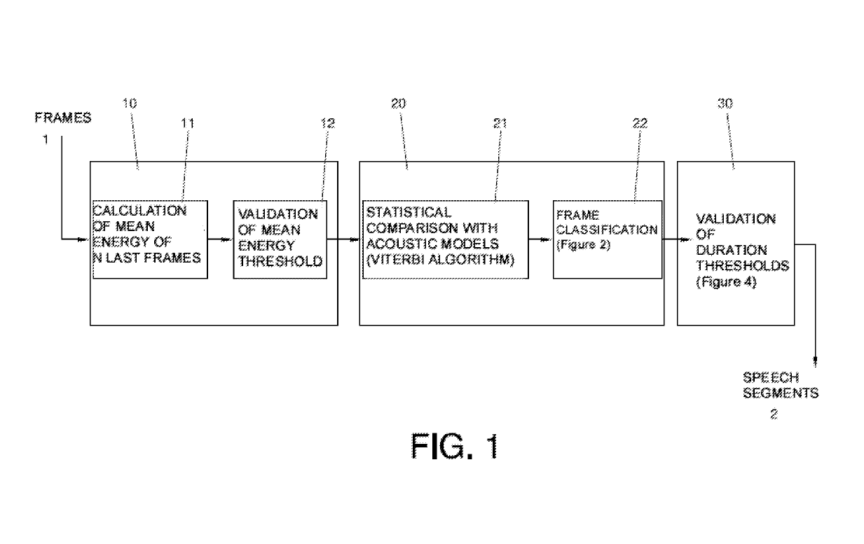

As is shown in FIG. 1, the energy is calculated for each frame 1 in a first stage 10. The average of the energy value for this frame and the previous N frames is calculated (block 11: calculation of mean energy of N last frames), where N is an integer the values of which vary depending on the environment; typically N=10 in environments with little noise and N>10 for noisy environments. Then, this mean value is compared (block 12: validation of mean energy threshold) with a first energy threshold Threshold_energ1, the value of which is modified in the second stage depending on the noise level, and the initial value thereof being configurable; typically, for frames of 10 ms, Threshold_energ1=15, which value can be adjusted according to the application. If the mean energy value of the last frames does not exceed said first energy threshold Threshold_energ1, the frame is definitively classified as noise and the processing thereof ends, the process of the next signal frame beginning. If, on contrast, the mean value does exceed said first energy threshold, the frame continues to be processed, passing to the second stage 20 of the method.

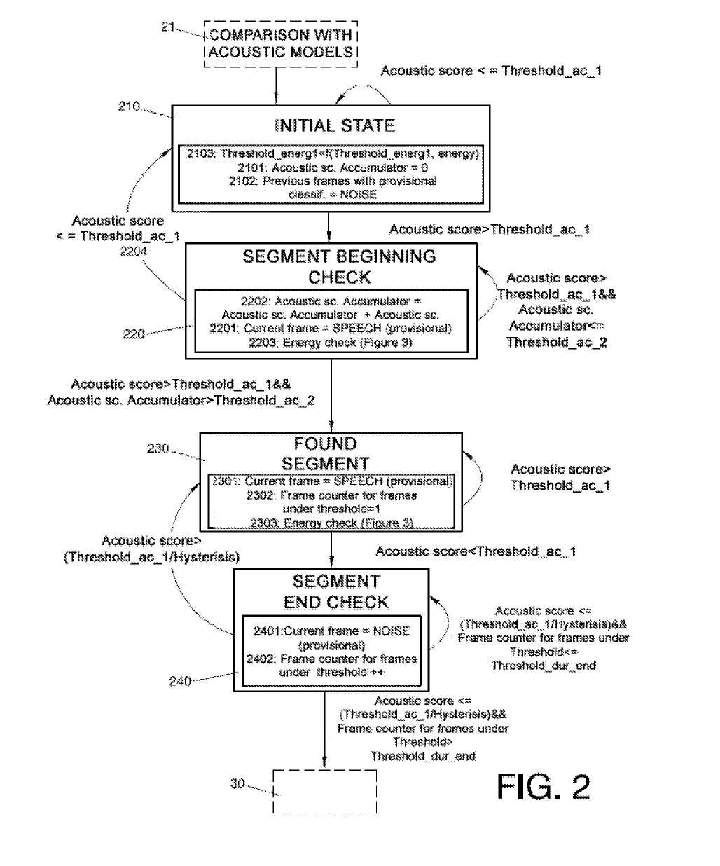

Two processes are performed in the second stage 20:
a statistical comparison of the frame which is being processed with acoustic speech and noise models (block 21: statistical comparison with acoustic models (Viterbi algorithm)), and
a frame classification process (block 22: frame classification) for classifying it as speech or noise (see FIG. 2).

In order to carry out the statistical comparison, a feature vector is first obtained which consists of a set of spectral parameters obtained from the signal. Specifically, a subset of the parameters forming the feature vector proposed in the ETSI ES 202 050 standard is selected.

How the subset of parameters is selected is described below:
The probability density functions of the value of each of the parameters for the speech frames and noise frames are first estimated from the values of the parameter obtained with a set of acoustic speech and noise signals different from those which will be analyzed.
The classification error probability of each parameter is calculated by using the estimated probability density functions.
A list of the parameters is created, ordered from a lower to a higher value of this error probability.
A subset formed by the N first parameters of the list is chosen, the value of N being comprised between 0 and 39. Typically N=5, but it can vary depending on the application.

The statistical comparison requires the existence of acoustic speech and noise models. Specifically, Hidden Markov Models (HMM) are used to statistically model two acoustic units: one represents the speech frames and the other one represents the noise frames. These models are obtained before using the method for the detection of noise and speech segments of the present invention. To that end, these acoustic units are previously trained using for that purpose recordings containing noise and speech segments labeled as such.

The comparison is carried out using the Viterbi algorithm. The probability that the current frame is a speech frame and the probability that it is a noise frame is thus determined from the feature vector obtained in the frame which is being processed, from the statistical speech and noise models, and from the comparison data of the previously processed frames. An acoustic score parameter calculated by dividing the probability that the frame is a speech frame by the probability that the frame is a noise frame is also calculated.

The frame classification process (block 22) is carried out by means of a decision-making process (see FIG. 2) which takes into account the acoustic score parameter obtained in the statistical comparison process 21 and other criteria, including the decisions of classifying previous frames as speech or noise.

This FIG. 2 depicts a state diagram, in which when a transition (for example, if the acoustic score is less than “threshold_ac_{—}1”) occurs, the state passes to that indicated by the arrow, and the processes included in said state are carried out. For this reason the processes appear in the next state once the transition has been made.

As is shown in FIG. 2, the steps of the decision-making process are the following:
Initial state 210: An acoustic score accumulator, Acoustic sc. Accumulator (2101), is set to zero. The possible previous frames which were provisionally classified as speech or as noise (2102) are classified as noise.

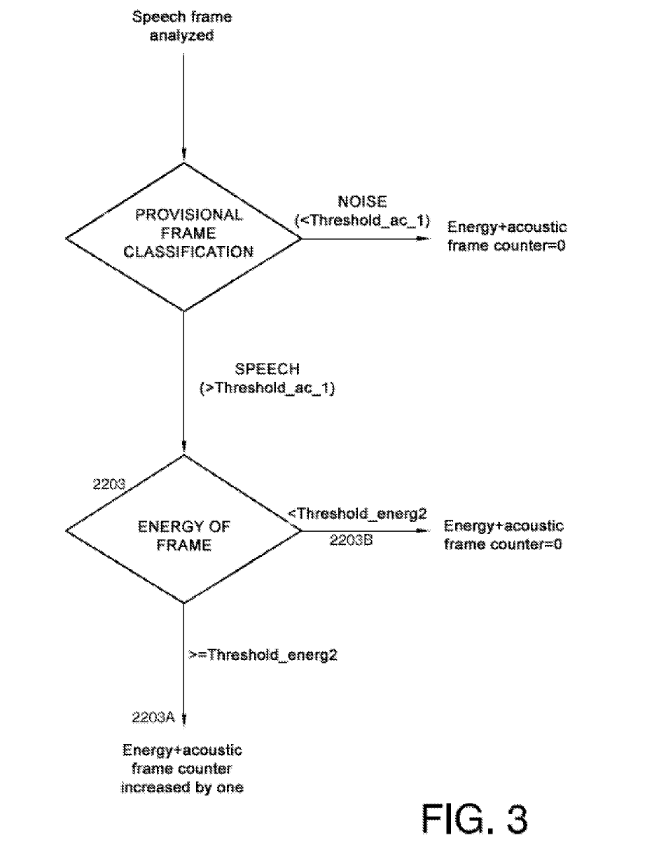

The acoustic score parameter obtained in the statistical comparison is then compared with a first acoustic threshold, Threshold_ac_{—}1.
A) If it does not exceed said first acoustic threshold Threshold_ac_{—}1 the following actions are performed:
   i) The current frame is definitively classified as noise (2102).
   ii) The first energy threshold used in the first stage, Threshold_energ1 (2103), is updated obtaining a mean (weighted by a memory factor) between its current value and the energy value of the current frame. The memory factor is a value between 0 and 1; it typically has a value of 0.9, which is adjustable depending on the application.
   iii) The next signal frame is then processed from the first stage 10 of the method.
B) In the event that the acoustic score parameter obtained in the statistical comparison exceeds said first acoustic threshold Threshold_ac_{—}1, the following actions are performed:
   i) The current frame is provisionally classified as speech (2201).
   ii) The value of the acoustic score accumulator is updated with the value of the acoustic score parameter obtained in the statistical comparison (2202).
   iii) It is checked (2203) if the energy of the signal exceeds a second energy threshold, Threshold_energ2 (see FIG. 3), calculated from the current value of the first energy threshold Threshold_energ1 (used in the first stage 10 of the method), the value of which is obtained by multiplying said first energy threshold Threshold_energ1 by a factor and adding an additional offset to it. This factor has a configurable value between 0 and 1, and the offset, also with a configurable value, can acquire both positive and negative values, its absolute value ranging between 0 and 10 times the value of the first energy threshold, Threshold_energ1. If it exceeds said second energy threshold, Threshold_energ2, a first consecutive frame counter for frames exceeding both the first acoustic threshold Threshold_ac_{—}1 (of the statistical comparison) and this second energy threshold Threshold_energ2 starts with value 1.
   iv) It passes to the next state: speech segment beginning check state 220.
   v) The next signal frame is then processed from the first stage 10 of the method.
Speech segment beginning check state 220: the acoustic score parameter obtained in the statistical comparison is compared with the first acoustic threshold, Threshold_ac_{—}1.
A) If it does not exceed said first acoustic threshold Threshold_ac_{—}1, the following actions are performed:
   i) Both the current frame and all the previous frames provisionally classified as speech are classified as noise (2102).
   ii) The acoustic score accumulator (2101) and the first consecutive frame counter for frames exceeding both the second energy threshold Threshold_energ_{—}2 and the first acoustic score threshold Threshold_ac_{—}1 are set to zero.
   iii) It is returned (2204) to the initial state 210.
   iv) The next signal frame is then processed from the first stage 10 of the method.
B) In the event that the acoustic score parameter obtained in the statistical comparison exceeds said first acoustic threshold Threshold_ac_{—}1, the following actions are performed:
   i) The current frame is provisionally classified as speech (2301 or 2201).
   ii) It is checked (2303 or 2203) if the energy of the signal exceeds the second energy threshold, Threshold_energ2 (see FIG. 3).
      If it exceeds it, the first consecutive frame counter for frames exceeding both the first acoustic threshold Threshold_ac_{—}1 of the statistical comparison and the second energy threshold Threshold_energ2 is increased (2203A in FIG. 3).
      If it does not exceed it, said first consecutive frame counter is set to zero (2203B in FIG. 3).
   iii) The value of the acoustic score accumulator (2202) is increased by adding the value of the acoustic score parameter obtained in the statistical comparison to it.
   iv) It is checked if the value of the acoustic score accumulator exceeds a second accumulated acoustic score threshold, Threshold_ac_{—}2.
      If it does not exceed said second acoustic threshold Threshold_ac_{—}2, the next signal frame is then processed from the first stage 10 of the method.
      If it exceeds said second acoustic threshold Threshold_ac_{—}2:
      1) It passes to the found speech segment state 230.
      2) The next signal frame is then processed from the first stage 10 of the method.
Found speech segment state 230: the acoustic score parameter obtained in the statistical comparison is compared with the first acoustic threshold, Threshold_ac_{—}1.
A) If the acoustic score parameter exceeds said first acoustic threshold Threshold_ac_{—}1, the following actions are performed:
   i) The current frame is provisionally classified as speech (2301).
   ii) It is checked (2303) if the energy of the signal exceeds the second energy threshold Threshold_energ2 (see FIG. 3).
      If it exceeds it, the first consecutive frame counter for frames exceeding both the first acoustic threshold Threshold_ac_{—}1 of the statistical comparison and the second energy threshold Threshold_energ2 is increased (2203A in FIG. 3).
      If it does not exceed it, said first consecutive frame counter is set to zero (2203B in FIG. 3).
   iii) The next signal frame is then processed from the first stage 10 of the method.
B) In the event that the acoustic score parameter obtained in the statistical comparison does not exceed the first acoustic threshold, Threshold_ac_{—}1, the following actions are performed:
   i) The current frame is provisionally classified as noise (2401).
   ii) It passes to the speech segment end check state 240.
   iii) a second consecutive frame number counter for frames not exceeding the modified acoustic threshold (the first time it must be under threshold_ac_{—}1 to start the counter; the counter increases are subsequently made when the modified threshold (divided by a hysteresis factor) is not exceeded) is started at 1 (2302).
   iv) The next signal frame is then processed from the first stage 10 of the method.
Speech segment end check state 240: The acoustic score parameter obtained in the statistical comparison is compared with a modified threshold resulting from dividing the first acoustic threshold Threshold_ac_{—}1 by a hysteresis factor, Hysteresis.
A) If the acoustic score parameter exceeds said modified threshold, Threshold_ac_{—}1/Hysteresis, the following actions are performed:
   i) The current frame is provisionally classified as speech. The previous frames which were provisionally classified as noise are also provisionally classified as speech (2301).
   ii) It is checked (2203 or 2303) if the energy of the signal exceeds the second energy threshold, Threshold_energ_{—}2.
      If it exceeds it, the first consecutive frame counter for frames exceeding both the modified threshold Threshold_ac_{—}1/Hysteresis of the statistical comparison and the second energy threshold Threshold_energ2 is increased (2203A in FIG. 3).
      If it does not exceed it, said first consecutive frame counter is set to zero (2203B in FIG. 3).
   iii) It passes to the found speech segment state 230.
   iv) The next signal frame is then processed from the first stage 10 of the method.
B) In the event that the acoustic score parameter obtained in the statistical comparison does not exceed the modified threshold Threshold_ac_{—}1/Hysteresis, the following actions are performed:
   i) The current frame is provisionally classified as noise (2401).
   ii) The second consecutive frame number counter for frames not exceeding the modified acoustic threshold is increased (2402).
   iii) It is checked if said second consecutive frame number counter for frames not exceeding the modified acoustic threshold, Threshold_ac_{—}1/Hysteresis is greater than an end of voice pulse search duration threshold, Threshold_dur_end. If it is greater, it passes to the third stage 30 of the method of detection.
   Otherwise, the next signal frame is then processed from the first stage 10 of the method.

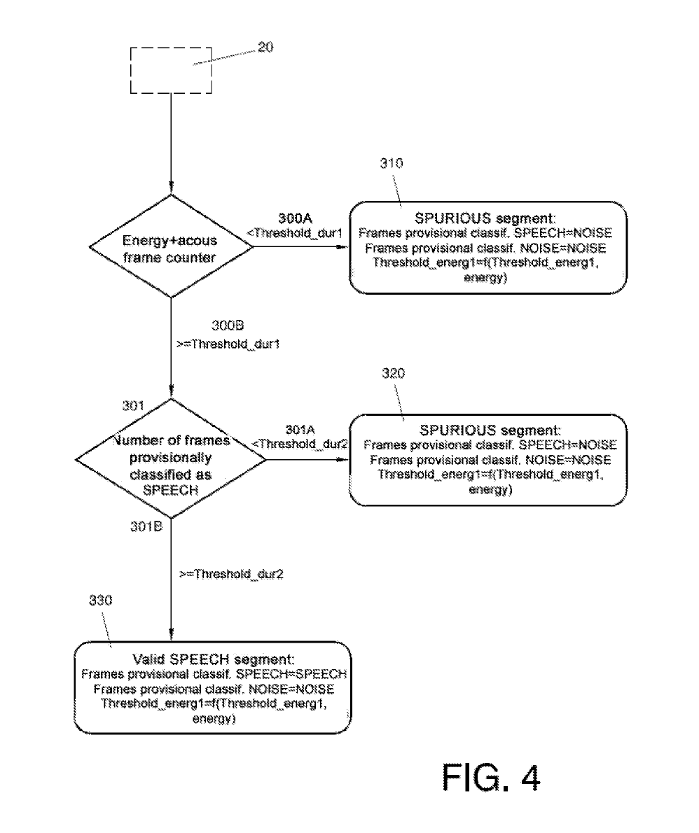

The speech/noise classification of the signal frames carried out in the second stage is reviewed in the third stage 30 of the method of the present invention using the criteria of duration in order to thus finally detect the speech segments 2. The following checks are made (see FIG. 4):
If the maximum value reached during the second stage 20 by the first consecutive frame counter for frames exceeding both the first acoustic threshold Threshold_ac_{—}1 and the second energy threshold Threshold_energ_{—}2 is less than (300A) a first duration threshold, Threshold_dur1, it is considered that the detected speech segment is spurious (310) and is discarded. Consequently, all the signal frames provisionally classified as speech and as noise which comply with this criterion are definitively classified as noise.
If the maximum value reached during the second stage 20 of said first counter is greater than or equal to (300B) said first duration threshold, Threshold_dur_{—}1, it is checked (301) if the total number of all the frames provisionally classified as speech exceeds a second duration threshold Threshold_dur2.
   In the event that it does not exceed it (301A), it is considered that the detected speech segment is spurious (320) and, consequently, all the signal frames provisionally classified as speech or as noise which comply with this criterion are definitively classified as noise.
   If this second duration threshold, Threshold_dur2, is exceeded (301B), the frames provisionally classified as speech are definitively classified as speech (330), and the frames provisionally classified as noise are definitively classified as noise.

The following actions are further carried out in the third stage:
The first energy threshold Threshold_energ1 used in the first stage 10 of the method is updated, obtaining a mean (weighted by a memory factor) between its current value and the energy value of the current frame.
The next signal frame is then processed from the first stage 10 of the method. In the event that said frame passes to the second stage 20 of the method, the decision-making process will begin from the initial state 210.

The invention has been described according to a preferred embodiment thereof, but for the person skilled in the art it will be evident that many variations can be introduced in said preferred embodiment.

1. Method for detection of noise and speech segments in a digital audio input signal, said input signal being divided into a plurality of frames comprising:
a first stage in which a first classification of a frame as noise is performed if a mean energy value for this frame and previous N frames is not greater than a first energy threshold, N being an integer greater than 1;
a second stage in which for each frame that has not been classified as noise in the first stage it is decided if said frame is classified as noise or as speech based on combining at least a first criterion of spectral similarity of the frame with acoustic noise and speech models, a second criterion of analysis of energy of the frame with respect to a second energy threshold and a third criterion of duration consisting of using a state machine for detecting a beginning of a segment as an accumulation of a determined number of consecutive frames with acoustic similarity greater than a first acoustic threshold and another determined number of consecutive frames with acoustic similarity less than said first acoustic threshold for detecting an end of said segment;
a third stage in which the classification as speech or as noise of the signal frames carried out in the second stage is reviewed using criteria of duration, classifying the speech segments having a duration of less than a first minimum segment duration threshold, as well as those which do not contain a determined number of consecutive frames simultaneously exceeding said acoustic threshold and said second energy threshold as noise.

2. Method according to claim 1, wherein two duration thresholds are used in said third stage:
a first minimum segment duration threshold, or minimum number of consecutive frames classified as speech or as noise;
a second duration threshold of consecutive frames which comply with both the criterion of spectral similarity and the criterion of analysis of the energy of the frame in the second stage.

3. Method according to claim 1, wherein said criterion of spectral similarity used in the second stage comprises a comparative analysis of spectral characteristics of said frame with spectral characteristics of said previously established acoustic noise and speech models.

4. Method according to claim 3, wherein said comparative analysis of spectral characteristics is performed using a Viterbi algorithm.

5. Method according to claim 1, wherein said previously established acoustic noise and speech models are obtained by statistically modeling two acoustic noise and speech units, respectively, by means of Hidden Markov Models.

6. Method according to claim 1, wherein the state machine comprises at least an initial state, a state in which it is checked that a speech segment has begun, a state in which it is checked that the speech segment continues, and a state in which it is checked that the speech segment has ended.

7. Method according to claim 6, wherein in the second stage, for each frame that has not been classified as noise in the first stage:
a probability that the frame is a noise frame is calculated by comparing spectral characteristics of said frame with those same spectral characteristics of a group of frames classified as noise which do not belong to the signal that is being analyzed;
a probability that the frame is a speech frame is calculated by comparing spectral characteristics of said frame with those same spectral characteristics of a group of frames classified as speech which do not belong to the signal that is being analyzed;
the next state of the state machine is calculated depending on at least a ratio between the probability that the frame is a speech frame and the probability that the frame is a noise frame, and on a current state of said state machine.

8. Method according to claim 7, wherein for a transition between the state in which it is checked that a speech segment has begun and the state in which it is checked that a speech segment continues to occur, at least two consecutive frames in which the ratio between the probability that the frame is a speech frame and the probability that the frame is a noise frame is greater than a first acoustic threshold are required.

9. Method according to claim 7, wherein for a transition between the state checking that a speech segment has ended and the initial state to occur, at least two consecutive frames in which the ratio between the probability that the frame is a speech frame and the probability that the frame is a noise frame is less than a first acoustic threshold divided by a factor.

10. Method according to claim 1, wherein the first energy threshold used in the first stage is dynamically updated by weighting its current value and the energy value of the frames classified as noise in the second and third stages.

11. Method according to claim 1, wherein a criterion of analysis of the energy of the frame comprises exceeding a second energy threshold calculated by multiplying the first energy threshold by a factor and adding an offset to it.
